(19) United States
(12) Patent Application Publication
(10) Pub. No.: US 2025/0095306 A1
(43) Pub. Date: Mar. 20, 2025

(54) METHOD FOR DISPLAYING AUGMENTED REALITY, DEVICE, STORAGE MEDIUM, AND TERMINAL

(71) Applicant: FALCON INNOVATIONS TECHNOLOGY (SHENZHEN) CO., LTD., Shenzhen (CN)

(72) Inventors: Cong WANG, Shenzhen (CN); Weizhe LI, Shenzhen (CN); Zhilong CAI, Shenzhen (CN); Huanhuan ZHAO, Shenzhen (CN); Jieming ZHANG, Shenzhen (CN)

(73) Assignee: FALCON INNOVATIONS TECHNOLOGY (SHENZHEN) CO., LTD., Shenzhen (CN)

(21) Appl. No.: 18/966,050

(22) Filed: Dec. 2, 2024

(30) Foreign Application Priority Data
Aug. 2, 2024 (CN) 202411054431.6

(51) Int. Cl. G06T 19/00; G06T 19/20

(52) U.S. Cl. CPC G06T 19/006; G06T 19/20; G06T 2219/2016

(57) ABSTRACT

A method for displaying augmented reality, a device, a storage medium, and a terminal are provided. A field of view and resolution of an augmented reality display device and a viewing angle of a user are acquired. A standard text width ratio of virtual information to be displayed is acquired. Then, a text display font size corresponding to the virtual information is determined according to the resolution, the field of view, the viewing angle, and the standard text width ratio. Further, a text display line height and a text display blank height corresponding to the virtual information can be determined based on the text display font size. Finally, a content of the virtual information is formatted and displayed according to the text display font size, the text display line height, and the text display blank height.

### CROSS REFERENCE TO RELATED APPLICATIONS

This application claims priority to Chinese Patent Applications No. 202411054431.6, filed on Aug. 2, 2024 and entitled “METHOD FOR DISPLAYING AUGMENTED REALITY, DEVICE, STORAGE MEDIUM, AND TERMINAL”. The entire disclosures of the above application are incorporated herein by reference.

### FIELD OF DISCLOSURE

The present application relates to the field of augmented reality technologies, and in particular to a method for displaying augmented reality, a device, a storage medium, and a terminal.

### BACKGROUND TECHNOLOGY

Augmented Reality (AR) technology is a technology that cleverly integrates virtual information with a real world. It simulates computer-generated virtual information such as text, images, three-dimensional models, music, and videos and applies them to the real world. AR terminal devices have micro-displays, optical engines, electronic circuits, etc., which can render and generate an information content required by a wearer and integrate and superimpose it with a real environment in a form of virtual imaging, presenting it in the wearer's scene. Similar to Virtual Reality (VR) and Mixed Reality (MR), AR is a subset of Extended Reality (XR). As used herein, XR and AR systems are described and referenced interchangeably. Unless stated otherwise, the descriptions herein apply equally to all types of mixed-reality systems, which (as detailed above) include AR systems, VR systems, and/or any other similar systems capable of displaying virtual objects.

It is understandable that the information content that the wearer needs changes in real time according to environment. A format of a virtual display image should change according to a specific information content, and adapt to a content of text, images, numbers, symbols, etc. In addition, the format of the virtual display image is also related to software and hardware parameters of a terminal device itself. The software and hardware parameters of terminal devices of different types and specifications are different, and even these software and hardware parameters of the same terminal device may change. At present, the AR terminal devices on the market do not take these into account when presenting virtual information content to the wearer. In some cases (such as when the information content is very large or very small), the whole image is very awkward and uncoordinated, giving the wearer a poor user experience.

### SUMMARY OF DISCLOSURE

Embodiments of the present application provide a method for displaying augmented reality, a device, a storage medium, and a terminal, which can improve a user experience.

An embodiment of the present application provides a method for displaying augmented reality, including: acquiring a field of view and resolution of an augmented reality display device, and a viewing angle of a user; acquiring a standard text width ratio of virtual information to be displayed; determining a text display font size corresponding to the virtual information according to the resolution, the field of view, the viewing angle, and the standard text width ratio; determining a text display line height and a text display blank height corresponding to the virtual information based on the text display font size; and formatting and displaying a content of the virtual information according to the text display font size, the text display line height, and the text display blank height.

In some embodiments, the resolution includes a length and a width of a virtual display image of the augmented reality display device; the determining the text display font size corresponding to the virtual information according to the resolution, the field of view, the viewing angle, and the standard text width ratio includes: determining a target display area width corresponding to the virtual information according to the length, the field of view, and the viewing angle; and determining the text display font size based on the target display area width and the standard text width ratio.

In some embodiments, the determining the target display area width corresponding to the virtual information according to the length, the field of view, and the viewing angle includes: calculating a first ratio according to the viewing angle and the field of view; and calculating a product of the first ratio and the length to obtain the target display area width.

In some embodiments, the determining the text display font size based on the target display area width and the standard text width ratio includes: calculating a product of the target display area width and the standard text width ratio to obtain a text display width of a single character; and determining the text display font size according to the text display width.

In some embodiments, the content of the virtual information includes a first type of text and a second type of text, and the standard text width ratio includes a first standard text width ratio corresponding to the first type of text and a second standard text width ratio corresponding to the second type of text; the determining the text display font size corresponding to the virtual information according to the resolution, the field of view, the viewing angle, and the standard text width ratio includes: determining a first text display font size corresponding to the first type of text according to the resolution, the field of view, the viewing angle, and the first standard text width ratio; and determining a second text display font size corresponding to the second type of text according to the resolution, the field of view, the viewing angle, and the second standard text width ratio.

In some embodiments, the determining the text display line height and the text display blank height corresponding to the virtual information based on the text display font size includes: acquiring a first preset line spacing corresponding to the first type of text and a second preset line spacing corresponding to the second type of text; calculating a difference between the first preset line spacing and the second preset line spacing; calculating the text display line height based on the difference, the second text display font size, and a preset coefficient; and determining the text display blank height based on the text display line height, where the text display blank height is not less than the text display line height.

In some embodiments, the method further includes: determining a text display line length corresponding to the virtual information based on the field of view; formatting and displaying the content of the virtual information according to the text display line length, the text display font size, the text display line height, and the text display blank height.

Accordingly, an embodiment of the present application further provides an augmented reality display device, including: a first acquisition unit configured to acquire a field of view and resolution of an augmented reality display device, and a viewing angle of a user; a second acquisition unit configured to acquire a standard text width ratio of virtual information to be displayed; a first determination unit configured to determine a text display font size corresponding to the virtual information according to the resolution, the field of view, the viewing angle, and the standard text width ratio; a second determination unit configured to determine a text display line height and a text display blank height corresponding to the virtual information based on the text display font size; and a display unit configured to format and display a content of the virtual information according to the text display font size, the text display line height, and the text display blank height.

In some embodiments, the resolution includes a length and a width of a virtual display image of the augmented reality display device; the first determination unit further includes: a first determination subunit configured to determine a target display area width corresponding to the virtual information according to the length, the field of view, and the viewing angle; and a second determination subunit configured to determine the text display font size based on the target display area width and the standard text width ratio.

In some embodiments, the first determination subunit is further configured to: calculate a first ratio according to the viewing angle and the field of view; and calculate a product of the first ratio and the length to obtain the target display area width.

In some embodiments, the second determination subunit is further configured to: calculate a product of the target display area width and the standard text width ratio to obtain a text display width of a single character; and determine the text display font size according to the text display width.

In some embodiments, the content of the virtual information includes a first type of text and a second type of text, and the standard text width ratio includes a first standard text width ratio corresponding to the first type of text and a second standard text width ratio corresponding to the second type of text; the first determination unit further includes: a third determination subunit configured to determine a first text display font size corresponding to the first type of text according to the resolution, the field of view, the viewing angle, and the first standard text width ratio; and a fourth determination subunit configured to determine a second text display font size corresponding to the second type of text according to the resolution, the field of view, the viewing angle, and the second standard text width ratio.

In some embodiments, the second determination unit further includes: a first acquisition subunit configured to acquire a first preset line spacing corresponding to the first type of text and a second preset line spacing corresponding to the second type of text; a first calculation subunit configured to calculate a difference between the first preset line spacing and the second preset line spacing; a second calculation subunit configured to calculate the text display line height based on the difference, the second text display font size, and a preset coefficient; and a fifth determination subunit configured to determine the text display blank height based on the text display line height, where the text display blank height is not less than the text display line height.

In some embodiments, the device further includes: a third determination unit configured to determine a text display line length corresponding to the virtual information based on the field of view; and a second display unit configured to format and display the content of the virtual information according to the text display line length, the text display font size, the text display line height, and the text display blank height.

Accordingly, an embodiment of the present application further provides a storage medium storing a plurality of instructions, where the instructions are suitable for being loaded by a processor to perform the method for displaying augmented reality as described above.

Accordingly, an embodiment of the present application further provides a terminal, including a processor and a memory, where the memory stores a plurality of instructions, and the processor loads the instructions to perform the method for displaying augmented reality as described above.

In the embodiments of the present application, the field of view and the resolution of the augmented reality display device and the viewing angle of the user are acquired; the standard text width ratio of the virtual information to be displayed is acquired; then, the text display font size corresponding to the virtual information is determined according to the resolution, the field of view, the viewing angle, and the standard text width ratio; further, the text display line height and text display blank height corresponding to the virtual information can be determined based on the text display font size; finally, the content of the virtual information is formatted and displayed according to the text display font size, the text display line height, and the text display blank height. In this way, it is convenient for the user to read the virtual information when wearing the augmented reality display device, and the user experience is improved. The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF DRAWINGS

To describe technical solutions in the embodiments of the present application more clearly, the following briefly introduces accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a flowchart of a method for displaying augmented reality provided by an embodiment of the present application.

FIG. 2 is a schematic diagram of an application scenario of a method for displaying augmented reality provided by an embodiment of the present application.

FIG. 3 is a schematic diagram displaying virtual information in a method for displaying augmented reality provided by an embodiment of the present application.

FIG. 4 is a schematic diagram of a format of a text display area in a method for displaying augmented reality provided by an embodiment of the present application.

FIG. 5 is a schematic diagram of a change of a text display line length with a field of view in a method for displaying augmented reality provided by an embodiment of the present application.

FIG. 6 is a block diagram of an augmented reality display device provided by an embodiment of the present application.

FIG. 7 is a schematic diagram of a terminal provided by an embodiment of the present application.

### DETAILED DESCRIPTION

The following will be combined with the accompanying drawings in the embodiments of the present application to clearly and completely describe the technical solutions in the embodiments of the present application. Apparently, the described embodiments are only part of the embodiments of the present application, not all of the embodiments. Based on the embodiments in the present application, all other embodiments obtained by those skilled in the art without creative efforts are within the scope of protection of the present application.

Embodiments of the present application provide a method for displaying augmented reality, a device, a storage medium, and a computer device. Specifically, the method for displaying augmented reality in the embodiments of the present application can be performed by a computer device. The computer device can be a local terminal or a remote server. The local terminal can be an AR device, including augmented reality wearable glasses and augmented reality head-mounted display. The remote server can be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), and big data and artificial intelligence platforms, etc.

For example, the method for displaying augmented reality can be performed on a server. The server can receive data collected by a terminal (which may include display parameters of an augmented reality display device and display information of virtual information to be displayed). A program of the method for displaying augmented reality is executed according to the received data to obtain an execution result. The execution result is then sent to the terminal so that the terminal controls the display of virtual information according to the execution result. The terminal and the server are connected in communication.

For example, the method for displaying augmented reality can be performed on a terminal, and the terminal can acquire a field of view and resolution of a augmented reality display device, and a viewing angle of a user; acquire a standard text width ratio of virtual information to be displayed; determine a text display font size corresponding to the virtual information according to the resolution, the field of view, the viewing angle, and the standard text width ratio; determine a text display line height and a text display blank height corresponding to the virtual information based on the text display font size; and format and display a content of the virtual information according to the text display font size, the text display line height, and the text display blank height.

Based on the above problems, the embodiments of the present application provide a method for displaying augmented reality, a device, a storage medium, and a terminal, which can improve the user experience. The following are detailed descriptions. It should be noted that the description order of the following embodiments is not intended to limit the preferred order of the embodiments.

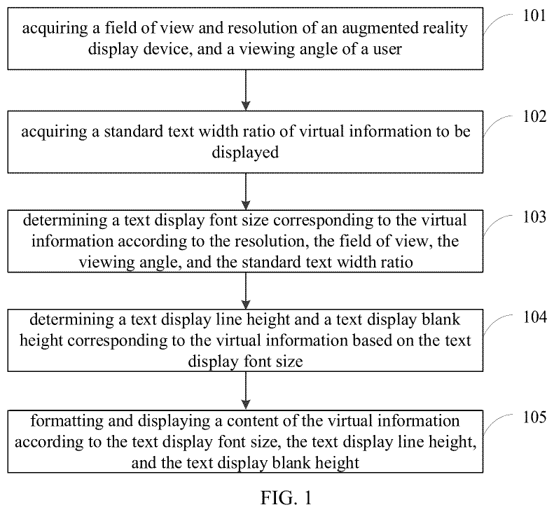

Please refer to FIG. 1, which is a flowchart of a method for displaying augmented reality provided by an embodiment of the present application. Taking the method for displaying augmented reality applied to a terminal as an example, the specific flow of the method for displaying augmented reality may be as follows.

101. Acquiring a field of view and resolution of an augmented reality display device, and a viewing angle of a user.

In the embodiments of the present application, the augmented reality display device, also known as an AR display device, refers to a display device that can enhance reality or virtual reality effects. The user's perceptual experience is enhanced by adding virtual information to a real world. Specifically, a simulated visual environment is provided through a physical display optical lens, allowing the user to see a digital display and the world through the glasses. Virtual images, videos, animations, or information content are provided to the wearer, allowing virtual elements to be added to the real world they can see through the glasses.

The augmented reality display device may include a wearable mobile terminal device, such as a head-mounted AR device, AR glasses, etc.

In some embodiments, the augmented reality display device in this solution may be a head-mounted AR device.

The field of view and the resolution are display parameters of the augmented reality display device. For most devices, they are fixed before the device is delivered from a factory, but may change during subsequent use. The field of view (FOV) represents a maximum range of a virtual equivalent screen where a virtual display content is located, that is, an angle between an edge of a screen and a line connecting eyes. A value of the FOV will directly affect a range of the virtual display image. The larger the angle, the wider the range of the virtual display image that the user can see. For example, the field of view can be 120 degrees, and a direction can be horizontal, that is, a horizontal field of view is 120 degrees. The resolution refers to a number of pixels that can be displayed in the virtual display image of the augmented reality display device. For example, the resolution is expressed as: length (number of pixels)×width (number of pixels).

In some embodiments, the field of view and the resolution of the augmented reality display device may be set before the device is delivered from a factory, and they are stored in the augmented reality display device as display parameters of the augmented reality display device. Then, the acquiring the field of view and the resolution of the augmented reality display device may include: reading the display parameters of the augmented reality display device to obtain the field of view and the resolution.

In some embodiments, the field of view and the resolution of the augmented reality display device may be stored in a server. That is, the server stores a device identifier (such as a device model, etc.) of the augmented reality display device and the corresponding display parameters (the display parameters at least include the resolution and the field of view, etc.). Then, the acquiring the field of view and the resolution of the augmented reality display device may include: acquiring the display parameters corresponding to the device model from the server according to the device model, thereby obtaining the field of view and the resolution.

In some embodiments, a triggering event for acquiring the field of view and the resolution of the augmented reality display device may include: when it is detected that the augmented reality display device needs to display information.

In some embodiments, the display parameters of the augmented reality display device may change. After the display parameters of the augmented reality display device change, in order to acquire accurate the field of view and the resolution and calculate appropriate content format information, it is necessary to re-acquire the display parameters of the augmented reality display device.

For example, when the hardware device of the augmented reality display device is replaced or repaired, it is necessary to re-acquire the display parameters of the augmented reality display device to acquire the field of view and the resolution of the augmented reality display device.

For example, after the augmented reality display device performs a system upgrade, it is necessary to re-acquire the display parameters of the augmented reality display device to acquire the field of view and the resolution of the augmented reality display device.

The viewing angle refers to a best angle of the text display area in the field of view of a wearer (i.e., the user wearing the augmented reality display device). The best angle can be data obtained from manual testing and pre-set in the system. Alternatively, the best viewing angle can be obtained by acquiring reading habits of the current user and analyzing the best observation field of view for the current user based on the reading habits.

In some embodiments, the best field of view of the current user obtained based on the reading habit analysis may include: acquiring eye movement information of the current user when watching virtual reality images while wearing the augmented reality display device multiple times within a historical time period, and calculating the best viewing angle of the current user based on the multiple eye movement information.

In some embodiments, the best viewing field of view of the current user obtained based on the reading habit analysis may include: acquiring adjustment information of the display area when the current user reads through other display devices multiple times in the historical time period, for example, setting the display area to a size of m×n, and then determining the best viewing angle when the current user reads based on the adjustment information. The best viewing angle may also be determined by other methods, which are not listed here one by one.

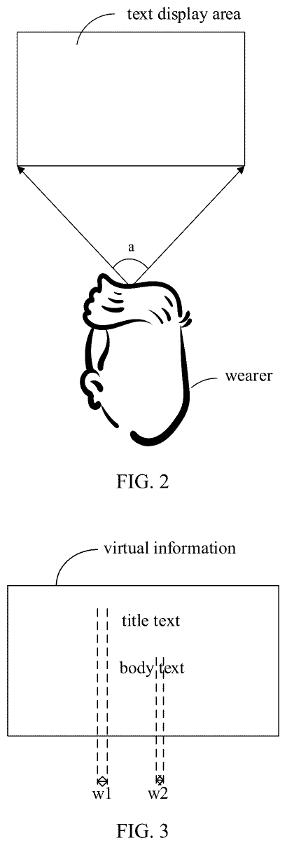

For example, please refer to FIG. 2, which is a schematic diagram of an application scenario of a method for displaying augmented reality provided by an embodiment of the present application. FIG. 2 shows a viewing angle a of a wearer viewing a text display area.

102. Acquiring a standard text width ratio of virtual information to be displayed.

The virtual information refers to information simulated and generated by computer technology, which can include text, images, etc. The virtual information can be displayed by superimposing it on a real environment through the augmented reality display device.

In the embodiments of the present application, the virtual information to be displayed refers to virtual information that needs to be displayed through the augmented reality display device, and the virtual information may include text content.

The standard text width ratio refers to a ratio of a standard design text width corresponding to a text in the virtual information to a standard design display area.

When the virtual information is generated, it will correspond to the standard design text width and the standard design display area. The standard design text width is a horizontal width of a single character in the text in the virtual information. The standard design display area is an area configured to display the text content in the virtual information.

That is, the standard design text width and the standard design display area width change with the virtual information. When the virtual information is determined, the data of the standard design text width and the standard design display area are also determined.

The standard design text width of the virtual information is preset. There are multiple ways to set the standard design text width. For example, the standard design text width can be set according to the text type in the virtual information. Different text types can correspond to different standard design text widths.

In some embodiments, the standard design text widths corresponding to different virtual information may be the same or different. When the virtual information to be displayed changes, the corresponding standard design text width and standard design display area will also change, and the standard design text width, the standard design display area, etc. of the virtual information need to be reacquired.

The standard design display area width refers to a standard design width of the text display area corresponding to the virtual information in the virtual display image of the augmented reality display device. The text display area can be configured to display the text content in the virtual information.

The standard design display area width may be initially set. There are multiple ways to set the standard design display area width. For example, the standard design display area width may be set according to the number of texts and text types in the virtual information. Different numbers of texts and/or text types may correspond to different display standard design area widths.

For example, the virtual information may be pop-up box information, and the standard design display area width may be a width of a pop-up box.

In some embodiments, the text in the virtual information may include multiple types of text, for example, may include a first type of text and a second type of text. The standard design text widths of the first type of text and the second type of text may be different.

A text width of the first type of text may be a first standard text width, and a text width of the second type of text may be a second standard text width.

For example, the first type of text may be title text, and the second type of text may be body text. A text width of the title text may be greater than a width of the body text.

For example, please refer to FIG. 3, which is a schematic diagram of a method for displaying augmented reality virtual information provided by an embodiment of the present application. The virtual information shown in FIG. 3 includes title text and body text. The standard design text width of the title text can be w1, and the standard design text width of the body text can be w2. The standard design text width of the title text is greater than the standard design text width of the body text, that is, w1>w2.

In some embodiments, the virtual information may also include a variety of other types of text, and other types of text also correspond to standard design text widths, which will not be described one by one here.

There are many ways to determine the standard text width ratio. For example, it can be determined based on a ratio of the standard design text width to the width of the standard design display area, or it can be determined based on the standard design text width and a style of the standard design display area.

In some embodiments, the acquiring the virtual information to be displayed of the standard text width ratio may include the following operations.

A ratio of the standard design text width to the width of the standard design display area is calculated to obtain the standard text width ratio.

Specifically, it can be calculated according to the following formula: r=w0/w; where w0 refers to the standard design text width corresponding to the virtual information, w refers to the width of the standard design display area corresponding to the virtual information, and r refers to the standard text width ratio.

In some embodiments, the virtual information may include the first type of text (such as the title text), and the acquiring the standard text width ratio of the virtual information to be displayed may include the following operations.

The ratio of the first standard design text width to the width of the standard design display area is calculated to obtain the first standard text width ratio.

Specifically, it can be calculated according to the following formula: r1=w1/w; where w1 refers to the first standard design text width corresponding to the first type of text in the virtual information, w refers to the width of the standard design display area corresponding to the virtual information, and r1 refers to the first standard text width ratio corresponding to the first type of text.

In some embodiments, the virtual information may include a second type of text (such as body text), and the acquiring the standard text width ratio of the virtual information to be displayed may include the following operations.

The ratio of the second standard design text width to the width of the standard design display area is calculated to obtain the second standard text width ratio.

Specifically, it can be calculated according to the following formula: r2=w2/w; where w2 refers to the second standard design text width corresponding to the second type of text in the virtual information, w refers to the width of the standard design display area corresponding to the virtual information, and r2 refers to the second standard text width ratio corresponding to the second type of text.

In some embodiments, the standard text width ratio can be determined according to the standard design text width and a style of the standard design display area. For example, the style of the standard design display area can include a wide shape (that is, the width of the area is larger) and a narrow shape (that is, the width of the area is smaller). When the style belongs to the wide shape, it can be determined that the number of characters displayed in a single line is large, that is, the standard text width ratio is small. When the style belongs to the narrow shape, it can be determined that the number of characters displayed in a single line is small, that is, the standard text width ratio is large.

103. Determining a text display font size corresponding to the virtual information according to the resolution, the field of view, the viewing angle, and the standard text width ratio.

The text display font size refers to a size of a single character when displaying text.

In some embodiments, the step of “determining the text display font size corresponding to the virtual information according to the resolution, the field of view, the viewing angle, and the standard text width ratio” may include the following operations: determining a target display area width corresponding to the virtual information according to the length, the field of view, and the viewing angle; determining the text display font size based on the target display area width and the standard text width ratio.

The target display area width refers to an optimal display width of the text display area in the virtual information in the virtual display image of the current augmented reality display device.

In some embodiments, the step of “determining the target display area width corresponding to the virtual information according to the length, the field of view, and the viewing angle” may include the following operations: calculating a first ratio according to the viewing angle and the field of view; calculating a product of the first ratio and the length to obtain the target display area width.

In the embodiment of the present application, a design formula is configured to calculate the target display area width, as follows: W=p×a/f; where p refers to a length in the resolution, a refers to the viewing angle, and f refers to the field of view. First, the ratio of the viewing angle a to the field of view f can be calculated as the first ratio, and then the product of the first ratio and the length p in the resolution is calculated to obtain the target display area width W.

The viewing angle a is an optimal viewing angle for ordinary people obtained through experimental testing. It may be a fixed constant or a group of constants preset in the AR device for the wearer to select and set, or it may be automatically generated based on the wearer's physiological characteristics, usage habits, personal preferences and other data.

In some embodiments, in order to prevent the target display area width from exceeding the virtual display image due to the user's viewing angle being greater than the field of view of the augmented reality device, the viewing angle may be compared with the field of view before calculating the target display area width.

For example, if the viewing angle is greater than the field of view, the target display area width can be calculated using the following formula: W=p×1; If the viewing angle is not greater than the field of view, the target display area width can be calculated using the following formula:

$$W = p \times a / f .$$

In some embodiments, the step of “determining the text display font size based on the target display area width and the standard text width ratio” may include the following operations: calculating a product of the target display area width and the standard text width ratio to obtain a text display width of a single character; determining the text display font size according to the text display width.

In the embodiment of the present application, a design formula is configured to calculate the text display font size, as follows: F=W×r; where W refers to the target display area width, and the product of the target display area width W and the standard text width ratio r is calculated to obtain the single character text display width F. Furthermore, the corresponding text display font size can be determined according to the text display width of the single character.

The correspondence between different text display widths and text display font sizes is preset, and after the text display width is calculated, the corresponding text display font size can be found from the correspondence according to the calculated text display width.

In some embodiments, when the virtual information includes multiple types of text, the display font sizes of the different types of text can be calculated respectively to facilitate user viewing. The step of “determining the text display font size corresponding to the virtual information according to the resolution, the field of view, the viewing angle, and the standard text width ratio” can include the following operations: determining a first text display font size corresponding to the first type of text according to the resolution, the field of view, the viewing angle, and the first standard text width ratio; determining a second text display font size corresponding to the second type of text according to the resolution, the field of view, the viewing angle, and the second standard text width ratio.

The determining the first text display font size corresponding to the first type of text according to the resolution, the field of view, the viewing angle, and the first standard text width ratio may include: determining the target display area width corresponding to the virtual information according to the length, the field of view, and the viewing angle. Then, the first text display font size is determined based on the display area width, the target display area width, the first standard text width, the field of view, and the viewing angle.

In the embodiment of the present application, a formula for calculating the first text display font size can be as follows: F1=W×r1; where W refers to the target display area width, and the product of the target display area width W and the first standard text width ratio r1 is calculated to obtain the text display width of the single character corresponding to the first type of text, that is, F1. Further, the corresponding text display font size can be determined according to the text display width of the single character corresponding to the first type of text: F1, as the first text display font size.

The correspondence between the text display width and the text display font size may be preset, and different text display widths may correspond to different text display font sizes. For example, the larger the text display width, the larger the corresponding text display font size.

The determining the second text display font size corresponding to the second type of text according to the resolution, the field of view, the viewing angle, and the second standard text width ratio may include: determining the target display area width corresponding to the virtual information according to the length, the field of view, and the viewing angle. Then, the second text display font size is determined based on the display area width, the target display area width, the second standard text width, the field of view, and the viewing angle.

In the embodiment of the present application, a formula for calculating the second text display font size can be as follows: F2=W×r2; where W refers to the target display area width, and the product of the target display area width W and the second standard text width ratio r2 is calculated to obtain the text display width of the single character corresponding to the second type of text, that is, F2. Further, the corresponding text display font size can be determined according to the text display width of the single character corresponding to the second type of text: F2 as the second text display font size.

Based on the above solution, the text display font size suitable for different device parameters and different viewing angles can be adaptively calculated according to the device parameters of the augmented reality display device and the user's viewing angle, so that the virtual display image and the text display font size are adapted to facilitate user reading.

104. Based on the text display font size, determining a text display line height and a text display blank height corresponding to the virtual information.

The text display line height refers to a height of a single line of text when displaying text.

The text display blank height refers to a height between the last line of text and a bottom of the text display area when displaying text.

In some embodiments, the step of “determining the text display line height and the text display blank height corresponding to the virtual information based on the text display font size” may include the following operations: acquiring a first preset line spacing corresponding to the first type of text and a second preset line spacing corresponding to the second type of text; calculating a difference between the first preset line spacing and the second preset line spacing; calculating the text display line height based on the difference, the second text display font size, and a preset coefficient; and determining the text display blank height based on the text display line height, where the text display blank height is not less than the text display line height.

The first preset line spacing refers to a distance between a baseline and a bottom line of a single text line of the first type of text. The second preset line spacing refers to a distance between a baseline and a bottom line of a single text line of the second type of text.

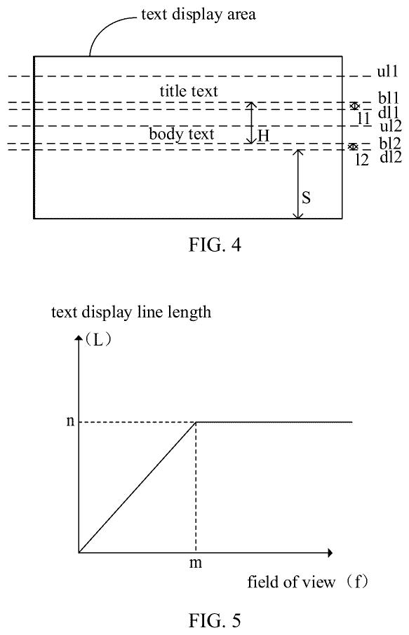

For example, please refer to FIG. 4, which is a schematic diagram of a format of a text display area in a method for displaying augmented reality provided by an embodiment of the present application. In the text display area of the virtual information as shown in FIG. 4, the first type of text is title text, and the second type of text is body text, ul1 is a top line of a text line of the title text, bl1 is a baseline of the text line of the title text, and dl1 is a bottom line of the text line of the title text. Also, ul2 is a top line of a text line of the body text, bl2 is a baseline of the text line of the body text, and dl2 is a bottom line of the text line of the body text.

l1 refers to a distance between the baseline and the bottom line of the text line of the title text, that is, a first preset line distance. l2 refers to a distance between the baseline and the bottom line of the text line of the body text, that is, a second preset line distance.

In an embodiment of the present application, the top line, the baseline, and the bottom line of the text line may be preset.

In an embodiment of the present application, a calculation formula for calculating the text display line height may be as follows: H=l1−l2+S2(k2+1)/2; where l1 refers to the first preset line spacing, l2 refers to the second preset line spacing, S2 is the second text display font size corresponding to the second type of text, and k2 is the preset coefficient (the preset coefficient can be a preset value). First, a difference between the first preset line spacing l1 and the second preset line spacing l2 can be calculated. A sum of k2 and 1 is calculated, and the sum is multiplied by the second text display font size: S2, and then divide the product by 2 to obtain a calculation result. Finally, the difference can be added to the calculation result to obtain the text display line height H.

Furthermore, the text display blank height may be determined according to the text display line height H. For example, the text display blank height may be set to be ≥the text display line height.

For example, please continue to refer to FIG. 4. In the text display area of the virtual information shown in FIG. 4, the height between the baseline bl1 of the text line of the title text and the baseline bl2 of the text line of the body text is calculated as the text display line height H. A height S between the bottom line dl2 of the text line of the body text and a bottom border of the text display area is the text display blank height, and S is greater than the text display line height H.

105. Formatting and displaying a content of the virtual information according to the text display font size, the text display line height, and the text display blank height.

Specifically, the formatting the text in the virtual information according to the calculated text display font size, the text display line height, and the text display blank height may include: setting a font size of the text in the virtual information to the text display font size, setting a distance between text lines in the virtual information to the text display line height, and setting the a blank distance in the virtual information to the text display blank height, thereby obtaining the formatted text. Then, the formatted text is displayed through the augmented reality display device, so that the user can efficiently read the text content displayed by the augmented reality display device.

In some embodiments, in order to ensure that the number of characters displayed in a single text line when displaying virtual information does not exceed the optimal viewing angle range for user reading, the method may further include the following steps: determining the text display line length corresponding to the virtual information based on the field of view; formatting and displaying the content of the virtual information according to the text display line length, the text display font size, the text display line height, and the text display blank height.

The text display line length refers to a length of a single line of text when displaying text. The text display line length can be configured to control the number of characters in a single text line.

In some embodiments, in order to improve the text display performance of the augmented reality display device, the step of “determining the text display line length of the virtual information to be displayed based on the field of view” may include the following operations: if the field of view is larger than a preset angle, acquiring a preset display line length to obtain the text display line length; if the field of view is not larger than the preset angle, calculating a product of the field of view and a first coefficient to obtain the text display line length.

The preset angle can be an actual field of view observed by the user. The larger the preset angle, the larger the horizontal distance observed by the user. Different people have their own personalized and comfortable field of view, which is generally within a range. The preset angle can be set in a variety of ways. For example, the system can collect relevant information for automatic setting, or the user can set it by himself through human-computer interaction.

For example, the system may collect relevant information for automatic setting, including: acquiring observation and reading habits of the current user, and setting the most suitable observation field of view for the current user as the preset angle according to the current user's reading habits. Alternatively, physiological data of the current user is acquired, and the system automatically calculates and predicts the most appropriate observation field of view as the preset angle.

For another example, the user setting may include: providing a parameter configuration interface. The parameter configuration interface may include a preset angle, and the user may set the preset angle in the parameter configuration interface. Alternatively, in the parameter configuration application, the user may set the preset angle by voice input.

In general, this preset angle can be configured from a range of 80-120 degrees.

In some embodiments, since different users observe different fields of view, different preset angles can be set according to different users.

In the embodiment of the present application, a first formula is designed to calculate the text display line length, as follows: L=k1×f, (f≤m); L=n, (f>m); where k1 is a first coefficient (the first coefficient may be a preset value), f is the field of view, and the product of k1 and f is calculated to obtain the text display line length L. Also, m is a preset angle, and in the embodiment of the present application, when the field of view f is less than or equal to the preset angle, the text display line length changes with the change of the field of view, that is, the larger the field of view, the longer the text display line length.

n is the preset display line length, that is, a maximum display line length. In the embodiment of the present application, when the field of view f is greater than the preset angle, the text display line length takes a fixed value, that is, the preset display line length. This avoids a situation where the text line length is too long, resulting in too many characters displayed in a single text line, affecting the user experience.

For example, please refer to FIG. 5, which is a schematic diagram of a change of a text display line length with a field of view in a method for displaying augmented reality provided by an embodiment of the present application. FIG. 5 shows a functional relationship between the text display line length L and the field of view f, including: when the field of view f is less than or equal to m, the text display line length increases as the field of view f increases; when the field of view f is greater than m, the text display line length is a fixed display line length n.

In the present application scheme, after determining the text display width through the above steps, the text display line length is further determined, so that the number of characters displayed in a single text line can be determined according to the text display width and the text display line length, which can further improve the display format performance of the virtual information.

The text in the virtual information is formatted according to the calculated text display line length, the text display font size, the text display line height, and the text display blank height, which may include: setting a single-line display length of the text in the virtual information to the text display line length; setting a font size of the text in the virtual information to the text display font size, setting a distance between text lines in the virtual information to the text display line height, and setting a text blank distance in the virtual information to the text display blank height, thereby obtaining the formatted text. Then, the formatted text is displayed through the augmented reality display device, so as to provide a good experience for the current user to view the virtual information through the virtual display image.

The embodiments of the present application disclose the method for displaying augmented reality. The method for displaying augmented reality includes: acquiring the field of view and the resolution of the augmented reality display device, and the viewing angle of the user; acquiring the standard text width ratio of the virtual information to be displayed; determining the text display font size corresponding to the virtual information according to the resolution, the field of view, the viewing angle, and the standard text width ratio; determining the text display line height and the text display blank height corresponding to the virtual information based on the text display font size; formatting and displaying the content of the virtual information according to the text display font size, text display line height, and text display blank height. In this way, it is convenient for the user to read the virtual information when wearing the augmented reality display device, thereby improving the user experience.

In order to better implement the method for displaying augmented reality provided in the embodiments of the present application, an embodiment of the present application also provides a device based on the above method for displaying augmented reality. The meaning of terms is the same as in the above method for displaying augmented reality, and specific implementation details can refer to the description in the method embodiments.

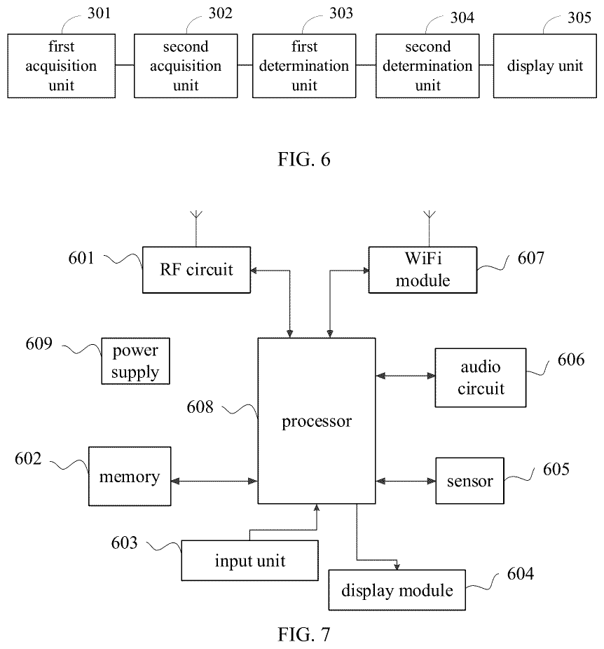

Please refer to FIG. 6, which is a block diagram of an augmented reality display device provided by an embodiment of the present application. The augmented reality display device can be applied to AR terminal devices such as augmented reality wearable glasses and augmented reality head-mounted displays. The device may include the following: a first acquisition unit 301 configured to acquire a field of view and resolution of an augmented reality display device, and a viewing angle of a user; a second acquisition unit 302 configured to acquire a standard text width ratio of virtual information to be displayed; a first determination unit 303 configured to determine a text display font size corresponding to the virtual information according to the resolution, the field of view, the viewing angle, and the standard text width ratio; a second determination unit 304 configured to determine a text display line height and a text display blank height corresponding to the virtual information based on the text display font size; and a display unit 305 configured to format and display a content of the virtual information according to the text display font size, the text display line height, and the text display blank height.

In some embodiments, the resolution includes a length and a width of a virtual display image of the augmented reality display device; the first determination unit 303 further includes: a first determination subunit configured to determine a target display area width corresponding to the virtual information according to the length, the field of view, and the viewing angle; and a second determination subunit configured to determine the text display font size based on the target display area width and the standard text width ratio.

In some embodiments, the first determination subunit can be specifically configured to: calculate a first ratio according to the viewing angle and the field of view; and calculate a product of the first ratio and the length to obtain the target display area width.

In some embodiments, the second determination subunit can be specifically configured to: calculate a product of the target display area width and the standard text width ratio to obtain a text display width of a single character; and determine the text display font size according to the text display width.

In some embodiments, the content of the virtual information includes a first type of text and a second type of text, and the standard text width ratio includes a first standard text width ratio corresponding to the first type of text and a second standard text width ratio corresponding to the second type of text; the first determination unit 303 further includes: a third determination subunit configured to determine a first text display font size corresponding to the first type of text according to the resolution, the field of view, the viewing angle, and the first standard text width ratio; and a fourth determination subunit configured to determine a second text display font size corresponding to the second type of text according to the resolution, the field of view, the viewing angle, and the second standard text width ratio.

In some embodiments, the second determination unit 304 further includes: a first acquisition subunit configured to acquire a first preset line spacing corresponding to the first type of text and a second preset line spacing corresponding to the second type of text; a first calculation subunit configured to calculate a difference between the first preset line spacing and the second preset line spacing; a second calculation subunit configured to calculate the text display line height based on the difference, the second text display font size, and a preset coefficient; and a fifth determination subunit configured to determine the text display blank height based on the text display line height, where the text display blank height is not less than the text display line height.

In some embodiments, the device further includes: a third determination unit configured to determine a text display line length corresponding to the virtual information based on the field of view; and a second display unit configured to format and display the content of the virtual information according to the text display line length, the text display font size, the text display line height, and the text display blank height.

The embodiment of the present application discloses the augmented reality display device. In the augmented reality display device, the first acquisition unit 301 acquires the field of view and the resolution of the augmented reality display device, and the viewing angle of the user. The second acquisition unit 302 acquires the standard text width ratio of the virtual information to be displayed. The first determination unit 303 determines the text display font size corresponding to the virtual information according to the resolution, the field of view, the viewing angle, and the standard text width ratio. The second determination unit 304 determines the text display line height and the text display blank height corresponding to the virtual information based on the text display font size. The display unit 305 formats and displays the content of the virtual information based on the text display font size, the text display line height, and the text display blank height. In this way, the user experience can be improved.

An embodiment of the present application also provides a terminal. As shown in FIG. 7, the terminal may include a radio frequency (RF) circuit 601, a memory 602 including one or more storage mediums, an input unit 603, a display module 604, a sensor 605, an audio circuit 606, a wireless fidelity (WiFi) module 607, a processor 608 including one or more processing cores, and a power supply 609. It can be understood by those skilled in the art that the terminal structure shown in FIG. 7 does not constitute a limitation on the terminal, and may include more or fewer components than shown in the figure, or combine certain components, or arrange the components differently.

The RF circuit 601 may be configured to receive and send signals in an information receiving and transmitting process. Especially, after receiving downlink information of a base station, the RF circuit 601 delivers the downlink information to the one or more processors 608 for processing, and in addition, sends related uplink data to the base station. Generally, the RF circuit 601 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 601 may also communicate with a network and another device by wireless communication.

The memory 602 may be configured to store a software program and module. The processor 608 runs the software program and module stored in the memory 602, to implement various functional applications and display augmented reality. The memory 602 mainly may include a program storage region and a data storage region. The program storage region may store an operating system, an application (for example, a voice playback function, or an image playback function) required by at least one function, and the like. In addition, the memory 602 may include a high speed random access memory, and may also include a non-volatile memory, such as at least one magnetic disk storage device, a flash memory, or another volatile solid-state storage device. Correspondingly, the memory 602 may also include a memory controller to provide the processor 608 and the input unit 603 with access to the memory 602.

The input unit 603 may be configured to receive input digit or character information, and generate a keyboard, mouse, joystick, optical, or track ball signal input related to user settings and functional control. Specifically, in a specific embodiment, the input unit 603 may include a touch sensitive surface and another input device. The touch sensitive surface, which may also be referred to as a touchscreen or a touch panel, may collect a touch operation of a user on or near the touch sensitive surface (such as an operation of a user on or near the touch sensitive surface by using any suitable object or accessory such as a finger or a stylus), and drive a corresponding connection apparatus according to a preset program. In addition to the touch-sensitive surface, the input unit 603 may further include another input device. Specifically, the another input device may include, but is not limited to, one or more of a physical keyboard, a functional key (such as a volume control key or a switch key), a track ball, a mouse, and a joystick.

The display module 604 may be used to display information input by a user or provided to a user and various graphic user interfaces of the server. The graphic user interfaces may be formed by a graphic, a text, an icon, a video, and any combination thereof. The display unit 604 may include a display panel, and in some embodiments, the display panel may be configured in a form of a liquid crystal display (LCD), an organic light-emitting diode (OLED), or the like. Further, the touch-sensitive surface may cover the display panel. After detecting a touch operation on or near the touch-sensitive surface, the touch-sensitive surface transfers the touch operation to the processor 608, so as to determine the type of the touch event. Then, the processor 608 provides a corresponding visual output on the display panel according to the type of the touch event.

The terminal may also include at least one sensor 605, such as a light sensor, a motion sensor, and other sensors. Specifically, the light sensor may include an ambient light sensor and a proximity sensor. The ambient light sensor may adjust the brightness of the display panel according to the brightness of the ambient light, and the proximity sensor may turn off the display panel and the backlight when the server is moved to the car.

The audio circuit 606, speakers, and microphones can provide an audio interface between the user and the server. The audio circuit 606 can transmit the electrical signal converted from the received audio data to the speaker, which converts it into a sound signal for output. On the other hand, the microphone converts the collected sound signal into an electrical signal. After being received by the audio circuit 606, it is converted into audio data, and then the audio data is output to processor 608 for processing, and then sent to a terminal, for example, through the RF circuit 601, or the audio data is output to memory 602 for further processing. The audio circuit 606 may also include an earphone jack to provide communication between an external headset and the server.

WiFi is a short-range wireless transmission technology. The terminal can help users send and receive emails, browse web pages, and access streaming media through the WiFi module 607, which provides users with wireless broadband Internet access. Although FIG. 7 shows the WiFi module 607, it is understandable that it is not a necessary component of the terminal and can be omitted as needed without changing the essence of the application.

The processor 608 is a control center of the terminal. It uses various interfaces and lines to connect various parts of the entire mobile phone. By running or executing software programs and modules stored in the memory 602, and calling data stored in the memory 602, it executes various functions of the server and processes data, thereby monitoring the mobile phone as a whole. Alternatively, the processor 608 may include one or more processing cores. Preferably, the processor 608 can integrate an application processor and a modem processor. The application processor mainly processes operating system, user interface, and application program, etc. The modem processor mainly processes wireless communication. It is understandable that the above-mentioned modem processor may not be integrated into the processor 608.

The terminal also includes a power supply 609 (such as a battery) that supplies power to various components. Preferably, the power supply can be logically connected to the processor 608 through a power supply management system, so that functions such as charging, discharging, and power consumption management can be implemented through the power supply management system. The power supply 609 may also include one or more DC or AC power supplies, recharging systems, power failure detection circuits, power converters or inverters, power status indicators, and other arbitrary components.

Specifically, in this embodiment, the processor 608 in the terminal will load the executable files corresponding to the processes of one or more applications into the memory 602 according to the following instructions, and the processor 608 will run the applications stored in the memory 602 to implement various functions: acquiring a field of view and resolution of an augmented reality display device, and a viewing angle of a user; acquiring a standard text width ratio of virtual information to be displayed; determining a text display font size corresponding to the virtual information according to the resolution, the field of view, the viewing angle, and the standard text width ratio; determining a text display line height and a text display blank height corresponding to the virtual information based on the text display font size; and formatting and displaying a content of the virtual information according to the text display font size, the text display line height, and the text display blank height.

In this solution, the field of view and the resolution of the augmented reality display device and the viewing angle of the user are acquired; the standard text width ratio of the virtual information to be displayed is acquired; then, the text display font size corresponding to the virtual information is determined according to the resolution, the field of view, the viewing angle, and the standard text width ratio; further, the text display line height and text display blank height corresponding to the virtual information can be determined based on the text display font size; finally, the content of the virtual information is formatted and displayed according to the text display font size, the text display line height, and the text display blank height. In this way, it is convenient for the user to read the virtual information when wearing the augmented reality display device, and the user experience is improved.

Those skilled in the art will appreciate that all or part of the steps in the various methods of the above embodiments may be completed through instructions, or through instructions controlling related hardware. The instructions may be stored in a storage medium and loaded and executed by a processor.

To this end, an embodiment of the present application provides a storage medium in which a plurality of instructions are stored, and the instructions can be loaded by a processor to execute the steps in any method for displaying augmented reality provided in the embodiments of the present application. For example, the instructions can perform the following steps: acquiring a field of view and resolution of an augmented reality display device, and a viewing angle of a user; acquiring a standard text width ratio of virtual information to be displayed; determining a text display font size corresponding to the virtual information according to the resolution, the field of view, the viewing angle, and the standard text width ratio; determining a text display line height and a text display blank height corresponding to the virtual information based on the text display font size; and formatting and displaying a content of the virtual information according to the text display font size, the text display line height, and the text display blank height.

The specific implementation of the above operations can be found in the previous embodiments, which will not be described in detail here.

The storage medium may include: a read-only memory (ROM), a random access memory (RAM), a magnetic disk, or an optical disk, etc.

Since the instructions stored in the storage medium can execute the steps in any method for displaying augmented reality provided in the embodiments of the present application, the beneficial effects that can be achieved by any method for displaying augmented reality provided in the embodiments of the present application can be achieved. For details, please refer to the previous embodiments and will not be repeated here.

The above is a detailed introduction to the method for displaying augmented reality, the device, the storage medium, and the terminal provided in the embodiments of the present application. Specific examples are used herein to illustrate the principles and implementation methods of the present application. The description of the above embodiments is only used to help understand the method and core idea of the present application. At the same time, for those skilled in the art, according to the idea of the present application, there will be changes in the specific implementation method and application scope. In summary, the content of this specification should not be understood as limiting the present application.

What is claimed is:

1. A method for displaying augmented reality, comprising:
acquiring a field of view and resolution of an augmented reality display device, and a viewing angle of a user;
acquiring a standard text width ratio of virtual information to be displayed;
determining a text display font size corresponding to the virtual information according to the resolution, the field of view, the viewing angle, and the standard text width ratio;
determining a text display line height and a text display blank height corresponding to the virtual information based on the text display font size; and
formatting and displaying a content of the virtual information according to the text display font size, the text display line height, and the text display blank height.

2. The method of claim 1, wherein the resolution comprises a length and a width of a virtual display image of the augmented reality display device;
wherein the determining the text display font size corresponding to the virtual information according to the resolution, the field of view, the viewing angle, and the standard text width ratio comprises:
determining a target display area width corresponding to the virtual information according to the length, the field of view, and the viewing angle; and
determining the text display font size based on the target display area width and the standard text width ratio.

3. The method of claim 2, wherein the determining the target display area width corresponding to the virtual information according to the length, the field of view, and the viewing angle comprises:
calculating a first ratio according to the viewing angle and the field of view; and
calculating a product of the first ratio and the length to obtain the target display area width.

4. The method of claim 2, wherein the determining the text display font size based on the target display area width and the standard text width ratio comprises:
calculating a product of the target display area width and the standard text width ratio to obtain a text display width of a single character; and
determining the text display font size according to the text display width.

5. The method of claim 1, wherein the content of the virtual information comprises a first type of text and a second type of text, and the standard text width ratio comprises a first standard text width ratio corresponding to the first type of text and a second standard text width ratio corresponding to the second type of text;
wherein the determining the text display font size corresponding to the virtual information according to the resolution, the field of view, the viewing angle, and the standard text width ratio comprises:
determining a first text display font size corresponding to the first type of text according to the resolution, the field of view, the viewing angle, and the first standard text width ratio; and
determining a second text display font size corresponding to the second type of text according to the resolution, the field of view, the viewing angle, and the second standard text width ratio.

6. The method of claim 5, wherein the determining the text display line height and the text display blank height corresponding to the virtual information based on the text display font size comprises:
acquiring a first preset line spacing corresponding to the first type of text and a second preset line spacing corresponding to the second type of text;
calculating a difference between the first preset line spacing and the second preset line spacing;
calculating the text display line height based on the difference, the second text display font size, and a preset coefficient; and
determining the text display blank height based on the text display line height, wherein the text display blank height is not less than the text display line height.

7. The method of claim 1, wherein the method further comprises:
determining a text display line length corresponding to the virtual information based on the field of view;
formatting and displaying the content of the virtual information according to the text display line length, the text display font size, the text display line height, and the text display blank height.

8. An augmented reality display device, wherein the device comprises:
a first acquisition unit configured to acquire a field of view and resolution of an augmented reality display device, and a viewing angle of a user;
a second acquisition unit configured to acquire a standard text width ratio of virtual information to be displayed;
a first determination unit configured to determine a text display font size corresponding to the virtual information according to the resolution, the field of view, the viewing angle, and the standard text width ratio;
a second determination unit configured to determine a text display line height and a text display blank height corresponding to the virtual information based on the text display font size; and
a display unit configured to format and display a content of the virtual information according to the text display font size, the text display line height, and the text display blank height.

9. The device of claim 8, wherein the resolution comprises a length and a width of a virtual display image of the augmented reality display device;
wherein the first determination unit further comprises:
a first determination subunit configured to determine a target display area width corresponding to the virtual information according to the length, the field of view, and the viewing angle; and
a second determination subunit configured to determine the text display font size based on the target display area width and the standard text width ratio.

10. The device of claim 9, wherein the first determination subunit is further configured to:
calculate a first ratio according to the viewing angle and the field of view; and
calculate a product of the first ratio and the length to obtain the target display area width.

11. The device of claim 9, wherein the second determination subunit is further configured to:
calculate a product of the target display area width and the standard text width ratio to obtain a text display width of a single character; and
determine the text display font size according to the text display width.

12. The device of claim 8, wherein the content of the virtual information comprises a first type of text and a second type of text, and the standard text width ratio comprises a first standard text width ratio corresponding to the first type of text and a second standard text width ratio corresponding to the second type of text; the first determination unit further comprises:
a third determination subunit configured to determine a first text display font size corresponding to the first type of text according to the resolution, the field of view, the viewing angle, and the first standard text width ratio; and
a fourth determination subunit configured to determine a second text display font size corresponding to the second type of text according to the resolution, the field of view, the viewing angle, and the second standard text width ratio.

13. The device of claim 12, wherein the second determination unit further comprises:
a first acquisition subunit configured to acquire a first preset line spacing corresponding to the first type of text and a second preset line spacing corresponding to the second type of text;
a first calculation subunit configured to calculate a difference between the first preset line spacing and the second preset line spacing;
a second calculation subunit configured to calculate the text display line height based on the difference, the second text display font size, and a preset coefficient; and
a fifth determination subunit configured to determine the text display blank height based on the text display line height, wherein the text display blank height is not less than the text display line height.

14. The device of claim 8, wherein the device further comprises:
a third determination unit configured to determine a text display line length corresponding to the virtual information based on the field of view; and
a second display unit configured to format and display the content of the virtual information according to the text display line length, the text display font size, the text display line height, and the text display blank height.

15. A storage medium storing a plurality of instructions, wherein the instructions are suitable for being loaded by a processor to perform:
acquiring a field of view and resolution of an augmented reality display device, and a viewing angle of a user;
acquiring a standard text width ratio of virtual information to be displayed;
determining a text display font size corresponding to the virtual information according to the resolution, the field of view, the viewing angle, and the standard text width ratio;
determining a text display line height and a text display blank height corresponding to the virtual information based on the text display font size; and
formatting and displaying a content of the virtual information according to the text display font size, the text display line height, and the text display blank height.

16. The storage medium of claim 15, wherein the resolution comprises a length and a width of a virtual display image of the augmented reality display device;
the processor is further configured to perform:
determining a target display area width corresponding to the virtual information according to the length, the field of view, and the viewing angle; and
determining the text display font size based on the target display area width and the standard text width ratio.

17. The storage medium of claim 16, wherein the processor is further configured to perform:
calculating a first ratio according to the viewing angle and the field of view; and
calculating a product of the first ratio and the length to obtain the target display area width.

18. The storage medium of claim 16, wherein the processor is further configured to perform:
calculating a product of the target display area width and the standard text width ratio to obtain a text display width of a single character; and
determining the text display font size according to the text display width.

19. The storage medium of claim 15, wherein the content of the virtual information comprises a first type of text and a second type of text, and the standard text width ratio comprises a first standard text width ratio corresponding to the first type of text and a second standard text width ratio corresponding to the second type of text;
wherein the processor is further configured to perform:
determining a first text display font size corresponding to the first type of text according to the resolution, the field of view, the viewing angle, and the first standard text width ratio; and
determining a second text display font size corresponding to the second type of text according to the resolution, the field of view, the viewing angle, and the second standard text width ratio.

20. The storage medium of claim 19, wherein the processor is further configured to perform:
acquiring a first preset line spacing corresponding to the first type of text and a second preset line spacing corresponding to the second type of text;
calculating a difference between the first preset line spacing and the second preset line spacing;
calculating the text display line height based on the difference, the second text display font size, and a preset coefficient; and
determining the text display blank height based on the text display line height, wherein the text display blank height is not less than the text display line height.
